(19) United States
(12) Patent Application Publication
(10) Pub. No.: US 2009/0285226 A1
(43) Pub. Date: Nov. 19, 2009

(54) NETWORK COMMUNICATION DEVICE AND IMPULSE NOISE PROTECTION METHOD

(75) Inventor: MENG-SHU LEE, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/212,661

(22) Filed: Sep. 18, 2008

(30) Foreign Application Priority Data
May 15, 2008 (CN) 200810301592.5

(51) Int. Cl. H04L 12/28

(52) U.S. Cl. 370/401

(57) ABSTRACT

A network communication device includes a protection value optimizing module, a rate calculating module, a rate determining module, and a connection module. The protection value optimizing module is configured for optimizing an impulse noise protection (INP) value. The rate calculating module is configured for calculating a first downlink rate based on an initial INP value and calculating a second downlink rate based on an optimized INP value. The rate determining module is configured for determining if the first downlink rate and the second downlink rate are greater than a maximum downlink rate provided by the central office device. The connection module is configured for establishing a communication connection between a terminal device and a central office device according to the second downlink rate and the optimized INP value upon the condition that the second downlink rate is not greater than the maximum downlink rate.

### BACKGROUND

1. Field of the Invention

Embodiments of the present disclosure relate to network communications, and particularly to a network communication device and an impulse noise protection method.

2. Description of Related Art

Presently, network communication devices, such as modems, routers, and gateways, are commonly used to establish a communication connection between a terminal device and a central office device. During the communication connection, the network communication device calculates a downlink rate based on an impulse noise protection (INP) value to establish the communication connection according to the INP value and the downlink rate. Larger INP values result in decreasingly smaller effects caused by impulse noise.

One such central office device requires the INP value to be greater than a minimum INP value, in addition to requiring the downlink rate to be smaller than a maximum downlink rate. The downlink rate decreases when the INP value increases, and the downlink rate increases when the INP value decreases. However, larger downlink rates and INP values result in increasingly better communication connections established by the network communication device.

When the network communication device requests the central office device to establish a communication connection between the terminal device and the central office device, the central office device transmits a minimum INP value and a maximum downlink rate to the network communication device. The network communication device usually calculates a downlink rate based on the minimum INP value to establish the communication connection according to the minimum INP value and the calculated downlink rate. However, because the minimum INP value is so small, the impulse noise reduces the efficiency of the network communication device. Therefore, a system and method for reducing the effect caused by the impulse noise is needed to overcome the aforementioned deficiencies.

### SUMMARY

One embodiment of the present disclosure provides a network communication device for establishing a communication connection between a terminal device and a central office device. The network communication device includes a protection value optimizing module, a rate calculating module, a rate determining module, and a connection module. The protection value optimizing module is configured for optimizing an impulse noise protection (INP) value so as to increase an efficiency of the communication connection between the terminal device and the central office device. The rate calculating module is configured for calculating a first downlink rate based on an initial INP value and calculating a second downlink rate based on an optimized INP value. The rate determining module is configured for determining if the first downlink rate and the second downlink rate are greater than a maximum downlink rate provided by the central office device. The connection module is configured for establishing the communication connection between the terminal device and the central office device according to the second downlink rate and the optimized INP value upon the condition that the second downlink rate is not greater than the maximum downlink rate. The protection value optimizing module optimizes the INP value upon the condition that at least one of the first downlink rate and the second downlink rate is greater than the maximum downlink rate.

Another embodiment of the present disclosure provides an impulse noise protection (INP) method for establishing a communication connection between a terminal device and a central office device. The INP method includes the following blocks: calculating a first downlink rate of the communication connection based on an initial INP value; determining if the first downlink rate is greater than a maximum downlink rate provided by the central office device; optimizing the INP value so as to increase an efficiency of the communication connection between the terminal device and the central office device if the first downlink rate is greater than the maximum downlink rate; calculating a second downlink rate based on the optimized INP value; determining if the second downlink rate is greater than the maximum downlink rate; and establishing the communication connection between the terminal device and the central office device according to the second downlink rate and the optimized INP value if the second downlink rate is not greater than the maximum downlink rate.

Other advantages and novel features of the present disclosure will become more apparent from the following detailed description of preferred embodiment when taken in conjunction with the accompanying drawings, in which:

### BRIEF DESCRIPTION OF THE DRAWINGS

FIG. 1 is a schematic diagram of an application environment and functional modules of a network communication device in accordance with one embodiment of the present disclosure;

FIG. 2 is a flowchart of one embodiment of an impulse noise protection method in accordance with the present disclosure; and

FIG. 3 is a flowchart of the impulse noise protection method in accordance with one embodiment of the present disclosure.

### DETAILED DESCRIPTION OF CERTAIN INVENTIVE EMBODIMENTS

All of the processes described below may be embodied in, and fully automated via, software code modules executed by one or more general purpose computers or processors. The code modules may be stored in any type of computer-readable medium or other computer storage device. Some or all of the methods may alternatively be embodied in specialized computer hardware.

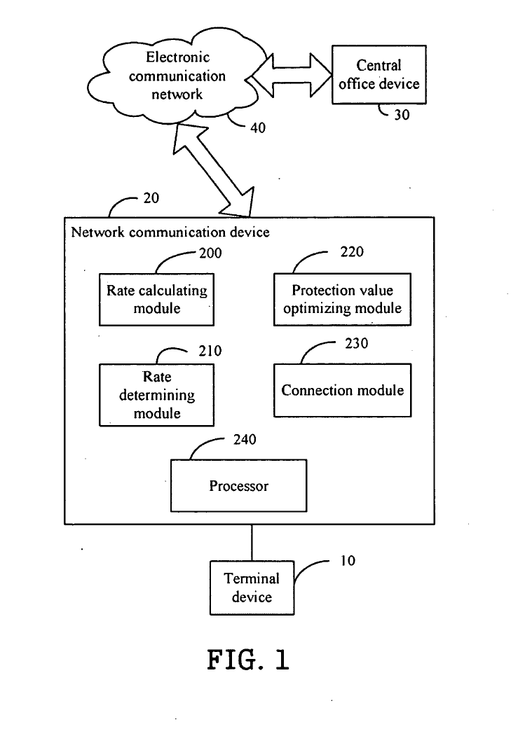

FIG. 1 is a schematic diagram of an application environment and functional modules of a network communication device 20 in accordance with one embodiment of the present disclosure. In one embodiment, the network communication device 20 is connected to a terminal device 10 and a central office device 30 via an electronic communication network 40. The terminal device 10 requires the use of a network accessing service, such as a computer or a set-top box, for example. The network communication device 20 is a network accessing device, such as a modem or a router, and offers network accessing services for the terminal device 10. The central office device 30 is a network communication device, such as a large-scale gateway, located in a central office. The electronic communication network 40 may be a digital subscriber line (DSL) broadband network.

Due to impulse noise, the network communication device 20 establishes a communication connection between the terminal device 10 and the central office device 30 according to an impulse noise protection (INP) value and a downlink rate. In one embodiment, the central office device 30 requires the INP value to be greater than a minimum INP value and the downlink rate to be less than a maximum downlink rate. In one embodiment, the network communication device 20 determines a proper INP value and a proper downlink rate to establish the communication connection between the terminal device 10 and the central office device 30 to reduce the effect caused by the impulse noise.

In one embodiment, the network communication device 20 includes a rate calculating module 200, a rate determining module 210, a protection value optimizing module 220, a connection module 230, and a processor 240. The central office device 30 transmits the minimum INP value and the maximum downlink rate to the network communication device 20 when the network communication device 20 requests the central office device 30 to establish one communication connection between the terminal device 10 and the central office device 30. The processor 240 executes the rate calculating module 200, the rate determining module 210, the protection value optimizing module 220, and the connection module 230. Depending on the embodiment, the processor 240 may comprise one or more general purpose or specialized processors.

The rate calculating module 200 is configured for calculating a first downlink rate based on an initial INP value. In one embodiment, the initial INP value is the minimum INP value provided by the central office device 30.

The rate determining module 210 is configured for determining if the first downlink rate is greater than the maximum downlink rate provided by the central office device 30. In one embodiment, if the first downlink rate is greater than the maximum downlink rate, the first downlink rate does not satisfy the requirements of the central office device 30. If the first downlink rate is not greater than the maximum downlink rate, the first downlink rate satisfies the requirements of the central office device 30.

The connection module 230 is configured for establishing a communication connection between the terminal device 10 and the central office device 30 according to the initial INP value and the first downlink rate upon the condition that the first downlink rate is not greater than the maximum downlink rate.

The protection value optimizing module 220 is configured for optimizing the INP value upon the condition that the first downlink rate is greater than the maximum downlink rate. In one embodiment, the protection value optimizing module 220 determines if the initial INP value is equal to zero when the first downlink rate is greater than the maximum downlink rate. If the initial INP value is not equal to zero, optimizing the INP value includes multiplying it by a number, such as 2 or 3. If the initial INP value is equal to zero, optimizing the INP value includes setting it to a nonzero value.

In other embodiments, optimizing the INP value may include adding a fixed value such as 0.5 or 1 to the INP value, among other means of optimization.

The rate calculating module 200 is further configured for calculating a second downlink rate based on an optimized INP value. The rate determining module 210 is further configured for determining if the second downlink rate is greater than the maximum downlink rate.

The protection value optimizing module 220 continues to optimize the INP value until the second downlink rate is not greater than the maximum downlink rate when the second downlink rate is greater than the maximum downlink rate. The second downlink rate satisfies the requirements of the central office device 30 when it is not greater than the maximum downlink rate. In such a case, the optimized INP value and the second downlink rate are both as greater as possible on the condition that the INP value and the second downlink rate both satisfy the requirements of the central office device 30. Thus, the network communication device 20 finds the proper INP value and downlink rate.

The connection module 230 is further configured for establishing a communication connection between the terminal device 10 and the central office device 30 according to the second downlink rate and the optimized INP value upon the condition that the second downlink rate is not greater than the maximum downlink rate.

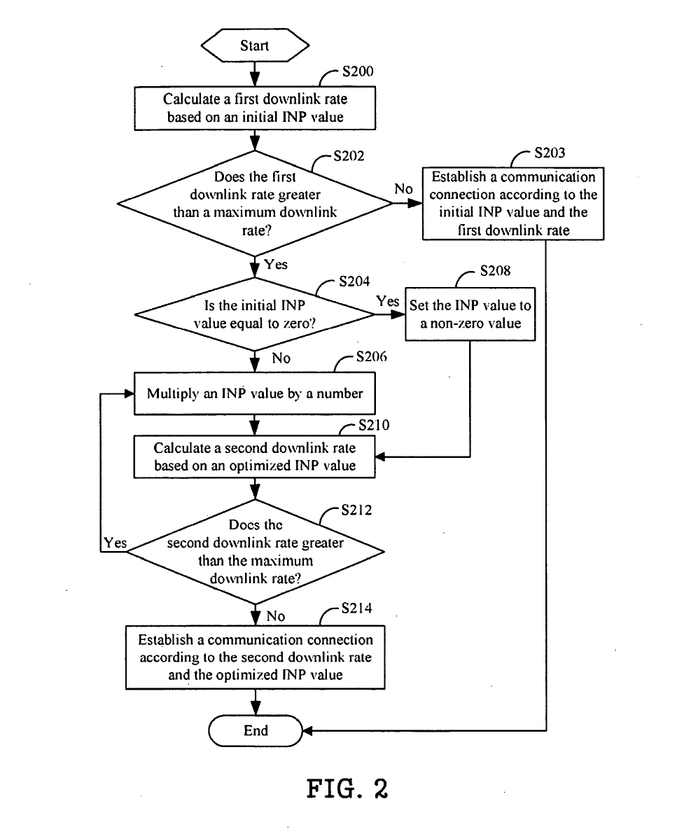

FIG. 2 is a flowchart of one embodiment of an INP method in accordance with the present disclosure. In one embodiment, the INP method is performed by the functional modules depicted in FIG. 1.

In block S200, the rate calculating module 200 calculates a first downlink rate based on an initial INP value. In one embodiment, the initial INP value is a minimum INP value provided by the central office device 30.

In block S202, the rate determining module 210 determines if the first downlink rate is greater than a maximum downlink rate provided by the central office device 30. In one embodiment, if the first downlink rate is greater than the maximum rate, the first downlink rate does not satisfy the requirements of the central office device 30. If the first downlink rate is not greater than the maximum rate, the first downlink rate satisfies the requirements of the central office device 30.

If the first downlink rate is not greater than the maximum downlink rate, in block S203, the connection module 230 establishes a communication connection between the terminal device 10 and the central office device 30 according to the initial INP value and the first downlink rate.

If the first downlink rate is greater than the maximum downlink rate, the protection value optimizing module 220 optimizes an INP value via blocks S204, S206, and S208.

In block S204, the protection value optimizing module 220 determines if the initial INP value is equal to zero.

If the initial INP value is not equal to zero, in block S206, the protection value optimizing module 220 multiplies the INP value by a number, such as 2 or 3.

If the initial INP value is equal to zero, in block S208, the protection value optimizing module 220 sets the INP value to a nonzero value.

In block S210, the rate calculating module 200 calculates a second downlink rate based on an optimized INP value.

In block S212, the rate determining module 210 determines if the second downlink rate is greater than the maximum downlink rate.

If the second downlink rate is greater than the maximum downlink rate, the above blocks S206, S210, and S212 will be repeated until the second downlink rate is not greater than the maximum downlink rate.

If the second downlink rate is not greater than the maximum downlink rate, in block S214, the connection module 230 establishes a communication connection between the terminal device 10 and the central office device 30 according to the second downlink rate and the optimized INP value.

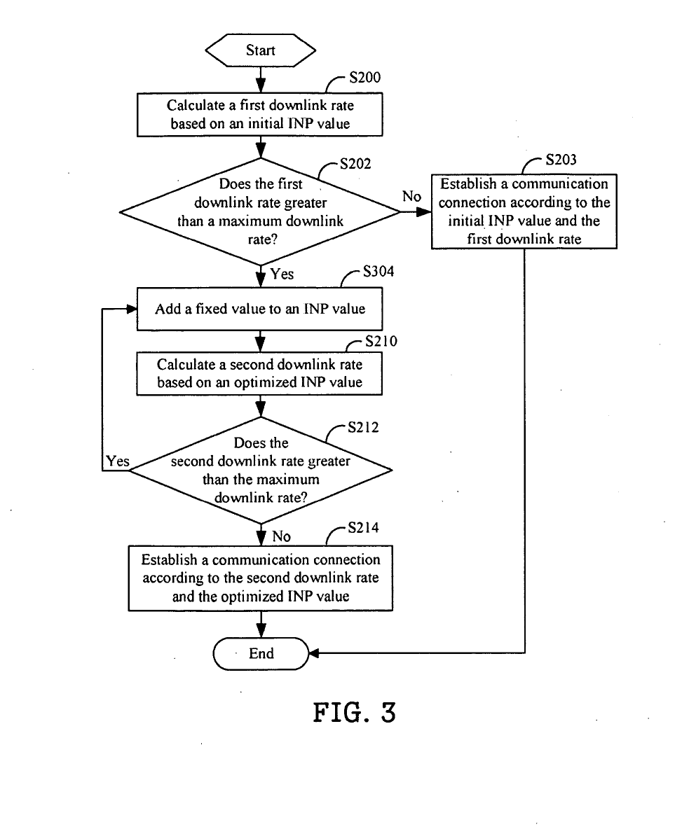

FIG. 3 is a flowchart of the INP method in accordance with another embodiment of the present disclosure. The INP method of this embodiment is similar to that of FIG. 2, the difference being that the protection value optimizing module 220 optimizes the INP value via block S304 instead of blocks S204, S206, and S208 if the first downlink rate is greater than the maximum downlink rate. In block S304, the protection value optimizing module 220 adds a fixed value to the INP value. The other blocks of FIG. 3 are the same as those of FIG. 2, so descriptions are omitted.

Thus, the network communication device 20 finds the proper INP value and downlink rate to establish the communication connection between the terminal device 10 and the central office device 30. Accordingly, the effect caused by the impulse noise is reduced, thereby improving the efficiency of the network communication device 20.

While various embodiments and methods of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A network communication device for establishing a communication connection between a terminal device and a central office device, the network communication device comprising:
a protection value optimizing module configured for optimizing an impulse noise protection (INP) value between the communication connection of the terminal device and the central office device so as to increase an efficiency of the communication connection between the terminal device and the central office device;
a rate calculating module configured for calculating a first downlink rate based on an initial INP value and calculating a second downlink rate based on an optimized INP value;
a rate determining module configured for determining if the first downlink rate and the second downlink rate are greater than a maximum downlink rate provided by the central office device; and
a connection module configured for establishing the communication connection between the terminal device and the central office device according to the second downlink rate and the optimized INP value upon the condition that the second downlink rate is not greater than the maximum downlink rate;
wherein the protection value optimizing module optimizes the INP value upon the condition that at least one of the first downlink rate and the second downlink rate is greater than the maximum downlink rate.

2. The network communication device of claim 1, wherein the connection module is further configured for establishing a communication connection between the terminal device and the central office device according to the first downlink rate and the initial INP value upon the condition that the first downlink rate is not greater than the maximum downlink rate.

3. The network communication device of claim 2, wherein the initial INP value is a minimum INP value provided by the central office device.

4. The network communication device of claim 1, wherein optimizing the INP value comprises adding a fixed value to the INP value.

5. The network communication device of claim 1, wherein the protection value optimizing module is further configured for determining if the initial INP value is equal to zero upon the condition that the first downlink rate is greater than the maximum downlink rate.

6. The network communication device of claim 5, wherein optimizing the INP value comprises multiplying the INP value by a number upon the condition that the initial INP value is not equal to zero, and setting the INP value to a nonzero value upon the condition that the initial INP value is equal to zero.

7. An impulse noise protection (INP) method for establishing a communication connection between a terminal device and a central office device, the INP method comprising:
calculating a first downlink rate of the communication connection based on an initial INP value;
determining if the first downlink rate is greater than a maximum downlink rate provided by the central office device;
optimizing an INP value so as to increase an efficiency of the communication connection between the terminal device and the central office device if the first downlink rate is greater than the maximum downlink rate;
calculating a second downlink rate based on the optimized INP value;
determining if the second downlink rate is greater than the maximum downlink rate; and
establishing the communication connection between the terminal device and the central office device according to the second downlink rate and the optimized INP value if the second downlink rate is not greater than the maximum downlink rate.

8. The INP method of claim 7, further comprising:
establishing a communication connection between the terminal device and the central office device according to the first downlink rate and the initial INP value if the first downlink rate is not greater than the maximum downlink rate.

9. The INP method of claim 8, wherein the initial INP value is a minimum INP value provided by the central office device.

10. The INP method of claim 7, wherein optimizing the INP value comprises adding a fixed value to the INP value.

11. The INP method of claim 7, further comprising:
determining if the initial INP value is equal to zero if the first downlink rate is greater than the maximum downlink rate;
multiplying the INP value by a number if the initial INP value is not equal to zero; or
setting the INP value to a nonzero value if the initial INP value is equal to zero.
